(19) United States
(12) Patent Application Publication
(10) Pub. No.: US 2005/0160228 A1
(43) Pub. Date: Jul. 21, 2005

(54) Equipment and method for cache replacement

(75) Inventor: Tatsuo Teruyama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/011,156

(22) Filed: Dec. 15, 2004

(30) Foreign Application Priority Data
Dec. 26, 2003 (JP) 2003-435789

(51) Int. Cl. G06F 12/00

(52) U.S. Cl. 711/133; 711/128; 711/3

(57) ABSTRACT

A cache replacement equipment encompasses a cache tag table having a plurality of ways, a thread comparator connected to the cache tag table configured to compare a first thread number stored in the cache tag table with a second thread number to be performed and a way determinator connected with the cache tag table and the thread comparator configured to determine one of the ways to be replaced.

### CROSS REFERENCE TO RELATED APPLICATIONS

This application is based upon and claims the benefit of priority from the prior Japanese Patent Applications No. P2003-435789, filed on Dec. 26, 2003; the entire contents of which are incorporated herein by reference.

### BACKGROUND OF THE INVENTION

1. Field of the Invention

The present invention relates to an equipment and method for cache replacement in cache control of a symmetric multiprocessing (SMP) system and a microprocessor making use of simultaneous multi-threading (SMT), when a cache of a set associative method is especially used.

2. Description of the Related Art

Since the cache for associative method are constituted by two or more ways, they must determine which way is replaced when a cache-missed occurs. It is necessary to choose a way from two or more ways which is replaced especially in the set associative method. There is a random method and the least recently used (LRU) method as the choosing method. The random method is the method of choosing an object at random out of a candidate. On the other hand, the LRU method is the method of choosing the way that has not been used over the longest period. Recently, using this LRU method or its approximating method, even when it is small, lowers the rate of a cache-missed being made.

### SUMMARY OF THE INVENTION

A aspect of the present invention inheres in a cache replacement equipment encompassing a cache tag table having a plurality of ways, a thread comparator connected to the cache tag table configured to compare a first thread number stored in the cache tag table with a second thread number to be performed and a way determinator connected with the cache tag table and the thread comparator configured to determine one of the ways to be replaced.

Another aspect of the present invention inheres in a cache replacement method including delivering a thread ID in each way of a cache tag table to a thread comparator, transferring a result to a way determinator after comparing a stored terminated thread ID with the thread ID in the thread comparator and determining a replaceable way based on the result and the least recently used way number in the cache tag table.

Still another aspect of the present invention inheres in a cache replacement method including delivering a thread ID in each way of a cache tag table indexed with a value of a counter to a way selector in an idle cycle of cache access by instructions, delivering an effective flag, a replacement way number and the least recently used way number to a way selector in the idle cycle, transferring a result of comparison of a terminated thread ID in the thread comparator with the thread ID from the thread comparator to the way determinator, supplying one of the replacement way number and the least recently used way number from the way selector to the way determinator based on the value of the effective flag and determining a replaceable way number and overwriting the replaceable way number onto the replacement way number of each way of the cache tag table indexed with the value of the counter, and setting the effective flag as ON by the way determinator.

### BRIEF DESCRIPTION OF DRAWINGS

FIG. 1 is the composition view of the cache replacement equipment concerning the form of implementation of a first embodiment of the present invention.

FIG. 2 is the composition view of the thread comparator concerning the form of implementation of the first embodiment of the present invention.

FIG. 3 is the view of the way determination algorithm concerning the form of implementation of the first embodiment of the present invention.

FIG. 4 is the composition view of the cache replacement equipment concerning the form of implementation of a second embodiment of the present invention.

FIG. 5 is the composition view of the thread comparator concerning the form of implementation of the second embodiment of the present invention.

FIG. 6 is the view of the way determination algorithm concerning the form of implementation of the second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

### FIRST EMBODIMENT

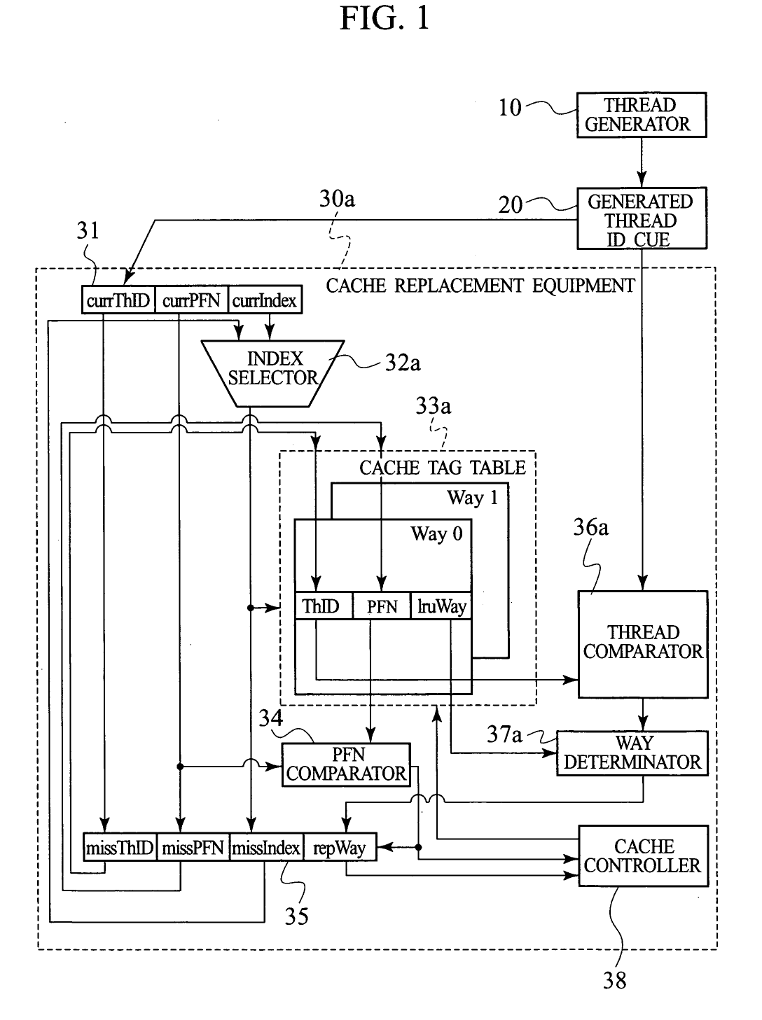

A cache replacement equipment 30a according to a first embodiment of the present invention comprises a cache tag table 33a consisted of a way 0 and a way 1, a thread comparator 36a connected to the cache tag table 33a, and a way determinator 37a connected to the cache tag table 33a as shown in FIG. 1. Moreover, the cache replacement equipment 30a possesses an index selector 32a connected to the cache tag table 33a, an instruction access address storage 31 connected to the index selector 32a, and a cache-missed address storage 35 connected to the index selector 32a and the instruction access address storage 31. The cache replacement equipment 30a possesses further a page frame number (PFN) comparator 34 connected to the cache tag table 33a and the instruction access address storage 31, and a cache controller 38 connected to the cache tag table 33a, the cache-missed address storage 35 and the PFN comparator 34.

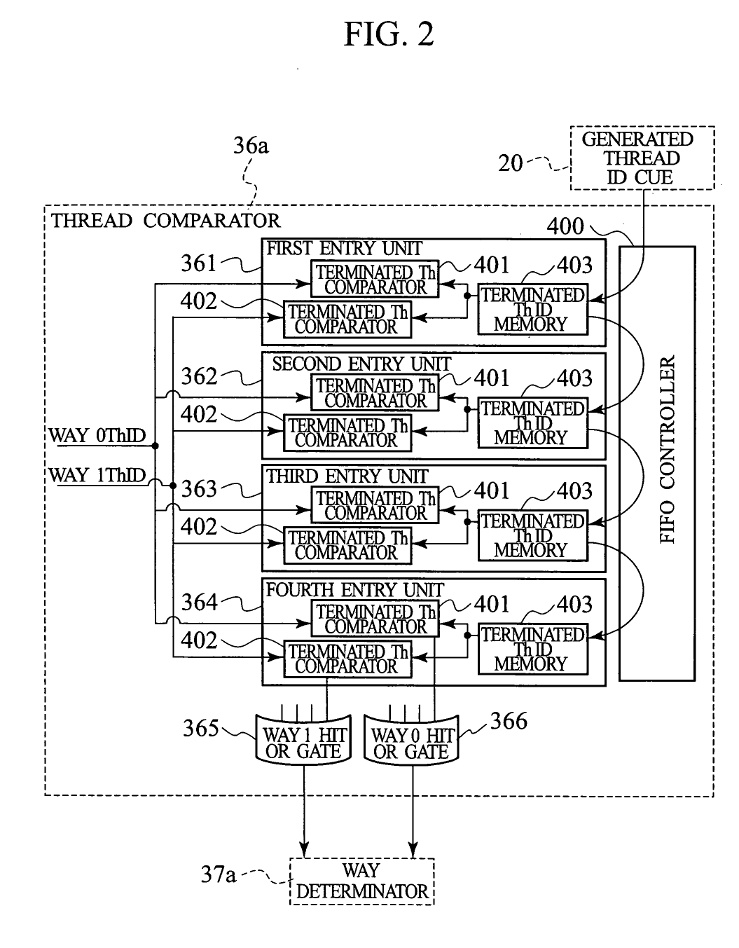

The thread comparator 36a comprises the first entry unit 361, the second entry unit 362, the third entry unit 363, the fourth entry unit 364, a first-in first-out (FIFO) controller 400, a way 0 hit OR gate 366 and a way 1 hit OR gate 365 as shown FIG. 2. There is a terminated thread ID (ThID) memory 403 which memorizes ID of terminated thread, and terminated thread comparators 401 and 402 which compare the ThID stored in each way of the cache tag table 33a with a terminated ThID memorized in the terminated ThID memory 403 in the first to fourth entry units 361, 362, 363, and 364. The terminated Th comparator 401 for way 0 is connected to the way 0 hit OR gate 366, and the terminated Th comparator 402 for way 1 is connected to the way 1 hit OR gate 365.

The cache tag table 33a is a memory table for memorizing and managing ThID, PFN and the least recently used way number (lruWay) of the threads which uses the memory. The index selector 32a selects an index for searching the cache tag table 33a at the time of thread execution and cache replacement.

The instruction access address storage element 31 is a register for storing the address of the memory that is consisted of a current thread ID (currThID), a current page frame number (currPFN) and a current index (currlndex).

The cache-missed address storage element 35 memorizes the data stored in the instruction access address storage element 31 as a missed thread ID (missThID), a missed page frame number (missPFN) and a missed index (missIndex). The cache-missed address storage element 35 stores a replaceable way number (RepWay) when cache-miss occurs.

The PFN comparator 34 outputs the comparison result of the current page frame number (currPFN) in the instruction access address storage 31 with the PFN of the cache tag table 33a to the cache controller 38 in order to judge the existence of cache miss during thread execution.

The way determinator 37a sets the replaceable way number (RepWay) determined by a way determination algorithm into the cache-missed address storage 35 when cache-miss occurs.

The cache controller 38 decides which way is accessed at thread execution and cache replacement. Moreover, the least recently used way number (lruWay) of the cache tag table 33a is set according to LRU.

The terminated ThID memory 403 of the thread comparator 36a memorizes a terminated thread ID detached from a created thread ID cue 20. And the first-in first-out (FIFO) controller 400 in the thread comparator 36a makes the terminated ThID be moved and memorized one by one from the terminated ThID memory 403 of the first entry unit 361 to the terminated ThID memory 403 of the fourth entry unit 364.

Moreover, terminated thread comparators 401 and 402 in the thread comparator 36a compare the terminated ThID memorized in the terminated ThID memory 403 with ThID stored in each way of the cache tag table 33a.

The way 0 hit OR gate 366 and the way 1 hit OR gate 365 in the thread comparator 36a examine the logical sum of outputs of the terminated Th comparators 401 and 402 in the first to fourth entry units 361, 362, 363, and 364, and output result whether data used by terminated threads is in each way to the way determinator 37a.

(The Cache Replacement Method)

(a) A thread ID generated in a thread generator 10 by a demand of processing is attached to a generated thread ID cue 20 one by one. The thread ID that comes to the turn of execution is detached from the generated thread ID cue 20. The thread ID is memorized in the instruction access address storage 31 as current thread ID (currThID) as well as stored in the terminated ThID memory 403 of the thread comparator 36a.

(b) A current page frame number (currPFN) and a current index (currindex) are stored in the instruction access address storage 31 as an address of the memory which thread with current thread ID accesses by the memory management unit (MMU) (not shown).

(c) The current index (currIndex) is chosen by the index selector 32a, and search of the cache tag table 33a is carried out by using the current index (currIndex).

(d) Next, the current page frame number (currPFN) stored in the instruction access address storage 31 is read and compared with PFN stored in the memory of the cache tag table 33a searched by the PFN comparator 34 by using the current index (currIndex). The result is notified to the cache controller 38 whether it is matched in each way. When there is a matched way, the PFN comparator 34 notifies coincidence of an address to the cache controller 38, and the cache controller 38 makes the data of the matched way to be used for processing, and sets the way number which was not matched as the least recently used way (lruWay). When there are no matched ways, cache replacement process is performed.

(Cache Replacement Process)

(e) The thread ID (ThID) stored in the memory of the cache tag table 33a and searched by thread comparator 36a using the current index (currlndex) is read from each way. The terminated ThID stored in each terminated ThID memory 403 is compared with ThID read from each way in the first to fourth entry units 361, 362, 363, and 364 by each terminated Th comparators 401 and 402. The logical sum of a comparison result is outputted to way determinator 37a by the way 0 hit OR gate 366 and the way 1 hit OR gate 365.

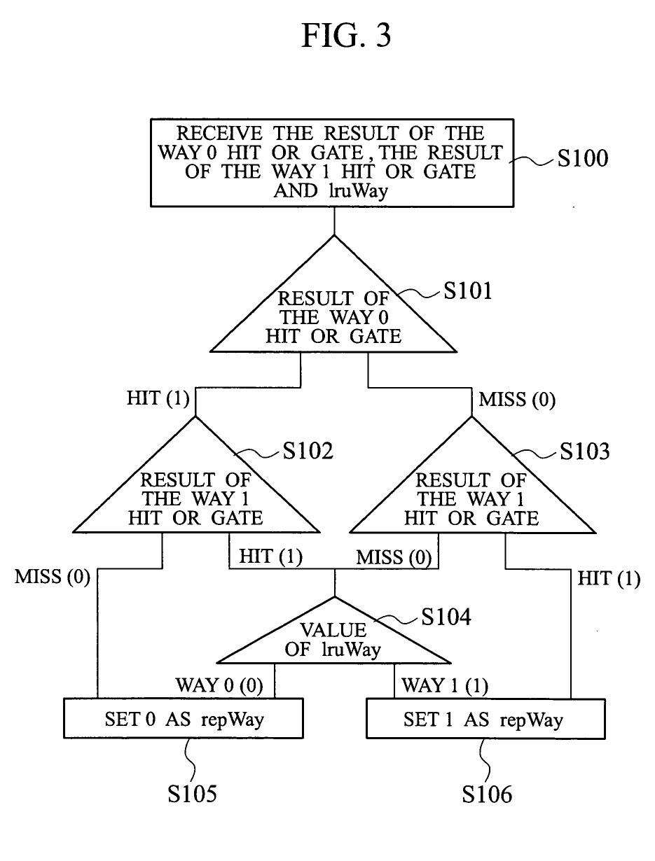

(f) Next, the way which should be replaced is determined by the way determinator 37a using the algorithm shown in FIG. 3. It is set as a replaceable way number (RepWay) in the cache-missed address storage 35. The algorithm is explained in full detail later.

(g) The current index (currindex) used for search, the current thread ID (currThID) stored in the instruction access address storage 31 and the current page frame number (currPFN) are set as the missed thread ID (missThID), the missed page frame number (missPFN), and the missed index (missIndex) in the cache-missed address storage 35, respectively.

(h) The cache controller 38 reads data from an external memory using the missed page frame number (missPFN) and the missed index (missIndex) as an address. The read data is written in a data area of cache memory (not shown).

(i) Then, the missed index (missindex) is chosen by the index selector 32a, and the cache tag table 33a is searched by using the missed index (missIndex).

(j) The cache controller 38 reads the replaceable way number (RepWay) in the cache-missed address storage 35. The cache controller 38 sets the missed thread ID (missThID) and the missed page frame number (missPFN) as an executing thread ID (ThID) and an executing page frame number (PFN) respectively to the way which should be replaced according to the replaceable way number (RepWay). Thereby, the replacement of cache is completed.

(Cache Replacement Algorithm)

S100: Receive the result of the way 0 hit OR gate 366 and the result of the way 1 hit OR gate 365. And read the least recently used way (lruWay) stored in the memory of the cache tag table 33a searched by using the current index (currIndex).

S101: The result of the way 0 hit OR gate 366 judges in 1 or 0. That is, it examines whether ThID stored in the way 0 is matched (hit=1) with either of four terminated ThIDs, or not (missed=0).

S102: In case the hit is made in S101, the result of the way 1 hit OR gate 365 judges in 1 or 0. That is, it examines whether ThID stored in the way 1 is matched (hit=1) with either of four terminated ThIDs, or not (missed=0).

S103: In case the miss is made in S101, the result of the way 1 hit OR gate 365 judges in 1 or 0. That is, it examines whether ThID stored in the way 1 is matched (hit=1) with either of four terminated ThIDs, or not (missed=0).

S104: In case the hit is made in S102, or the miss is made in S103, judge the value of lruWay.

S105: In case the miss is made in S102 or lruWay=0 in S104, set 0 as the replaceable way number (RepWay) in the cache-missed address storage 35.

S106: In case the hit is made in S103 or lruWay=1 in S104, set 1 as the replaceable way number (RepWay) in the cache-missed address storage 35.

The following logic is realized by this algorithm:
When only ThID of the way 0 is matched with the terminated ThID, set the way 0 as a replaceable way number (RepWay).
When only ThID of a way 1 is matched with the terminated ThID, set the way 1 as a replaceable way number (RepWay).
When ThID of both ways is matched with the terminated ThID or all are not matched, set the value of lruWay already stored in the memory of cache tag table 33a as a replaceable way number (RepWay).

According to the cache replacement equipment 30a and the cache replacement method according to the first embodiment, the cache used by the terminated thread can be replaced, and the use efficiency of cache goes up and a decline in the rate of a miss-hit can be expected.

### SECOND EMBODIMENT

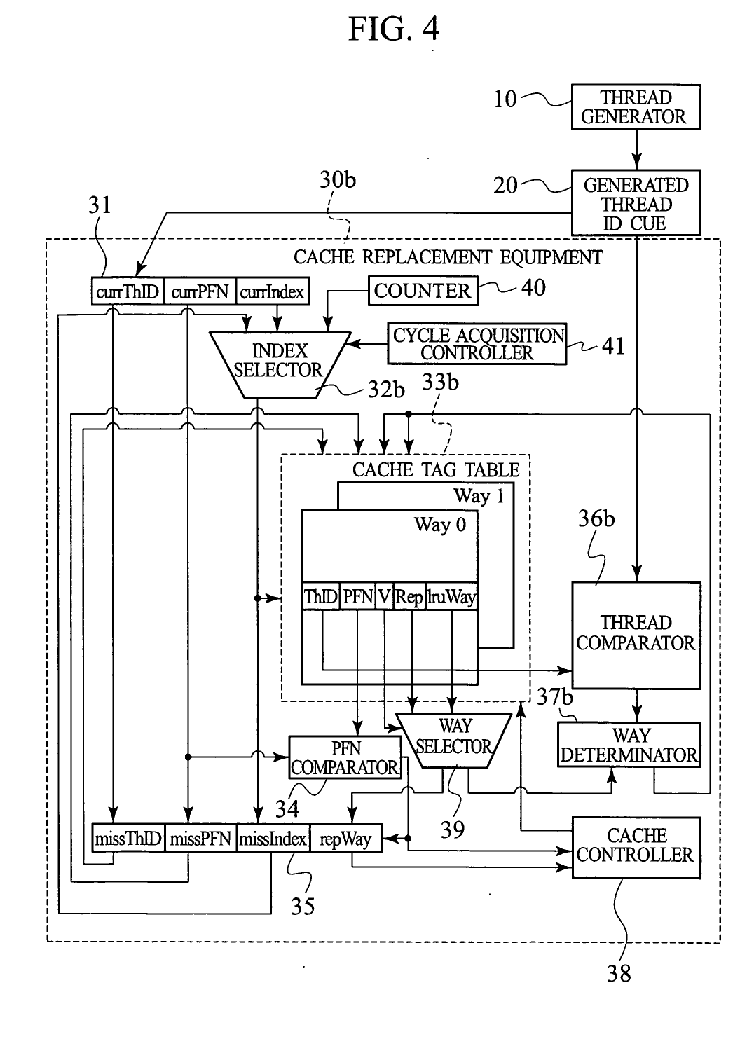

A cache replacement equipment 30b according to a second embodiment of the present invention comprises a cache tag table 33b consisting of a way 0 and a way 1, a thread comparator 36b connected to the cache tag table 33b, and a way determinator 37b connected to the cache tag table 33b as shown in FIG. 4. Moreover, the cache replacement equipment 30b possesses an index selector 32b connected to the cache tag table 33b, an instruction access address storage 31, a counter 40 and a cycle acquisition controller 41, which are connected to the index selector 32b, and a cache-missed address storage 35 connected to the instruction access address storage 31. The cache replacement equipment 30b possesses further a page frame number (PFN) comparator 34 connected to the cache tag table 33b and the instruction access address storage 31, and a way selector 39 connected to the cache tag table 33b, the cache-missed address storage 35 and the way determinator 37b, and a cache controller 38 connected to the cache tag table 33b, the cache-missed address storage 35 and the PFN comparator 34.

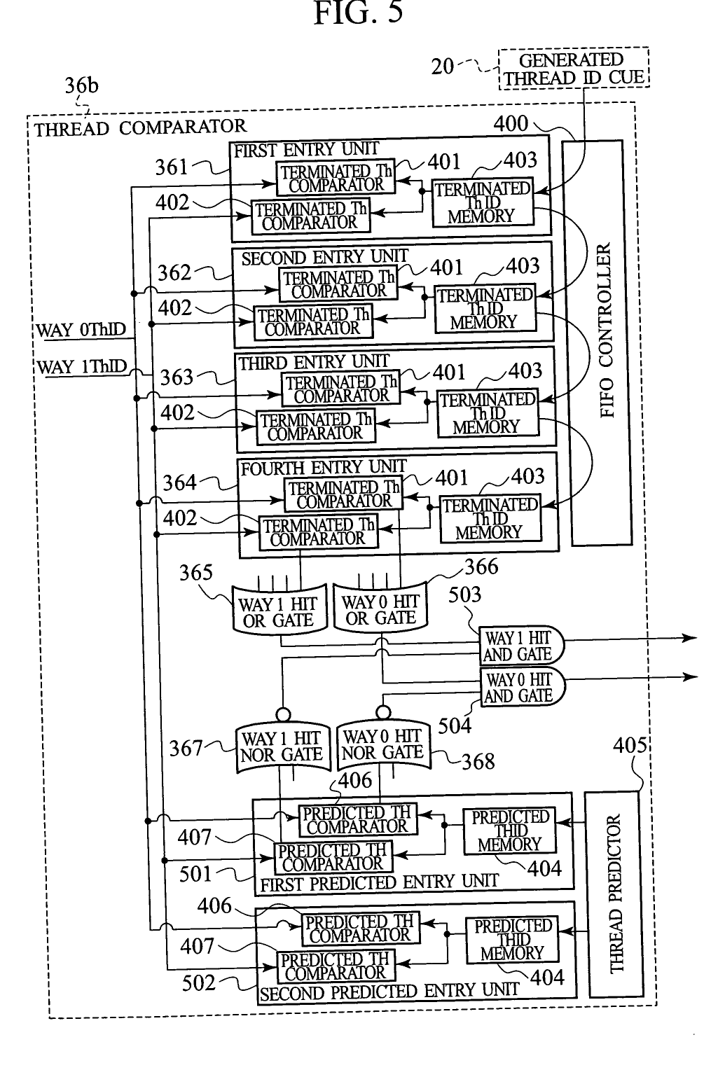

The thread comparator 36b comprises the first entry unit 361, the second entry unit 362, the third entry unit 363, the fourth entry unit 364, a first-in first-out (FIFO) controller 400 connected to these entry units, a way 0 hit OR gate 366, and a way 1 hit OR gate 365 as shown in FIG. 5. The thread comparator 36b further possesses the first predicted entry unit 501, the second predicted entry unit 502, and a thread predictor 405, a way 0 hit NOR gate 368 and a way 1 hit NOR gate 367 connected to these predicted entry units. Moreover, the thread comparator 36b possesses a way 0 hit AND gate 504 connected to the way 0 hit OR gate 366 and the way 0 hit NOR gate 368, and a way 1 hit AND gate 503 connected to the way 1 hit OR gate 365 and the way 1 hit NOR gate 367.

There is a terminated thread ID (ThID) memory 403 which memorizes ID of terminated thread, and terminated thread comparators 401 and 402 which compare the ThID stored in each way of the cache tag table 33b with a terminated ThID memorized in the terminated ThID memory 403 in the first to fourth entry units 361, 362, 363, and 364. The terminated Th comparator 401 for way 0 is connected to the way 0 hit OR gate 366, and the terminated Th comparator 402 for way 1 is connected to the way 1 hit OR gate 365.

There is a predicted ThID memory 404 which memorizes ID of thread predicted by the thread predictor 405, and predicted thread comparators 406 and 407 which compare ThID stored in each way of the cache tag table 33b with the predicted ThID memorized in the predicted ThID memory 404 in the first predicted entry unit 501 and the second predicted entry unit 502. The predicted thread comparator 406 for way 0 is connected to the way 0 hit NOR gate 368, and the predicted Th comparator 407 for way 1 is connected to the way 1 hit NOR gate 367.

The cache tag table 33b is a memory table for memorizing and managing ThID, PFN, the least recently used way number (lruWay), replacement way number effective flag (V) and replacement way number (Rep) of the threads which uses the memory. The counter 40 adds one to an index value up to the maximum number of the cache tag table 33b for carrying out the index of the cache tag table 33b whenever the index value in the counter 40 is read by the index selector 32b.

The cycle acquisition controller 41 finds the cycle in which the cache is not accessed by executed threads out of instruction execution cycles. The index selector 32b selects the index for carrying out the index of the cache tag table 33b at thread execution, at replacement way number setup and at cache replacement, respectively.

The instruction access address storage 31 is a register for storing the address of the memory that is consisted of a current thread ID (currThID), a current page frame number (currPFN) and a current index (currIndex).

The cache-missed address storage 35 memorizes the data stored in the instruction access address storage 31 as a missed thread ID (missThID), a missed page frame number (missPFN) and a missed index (missIndex). The cache-missed address storage 35 stores a replaceable way number (RepWay) when cache miss occurs.

The PFN comparator 34 outputs the comparison result of the current page frame number (currPFN) in the instruction access address storage 31 with the PFN of the cache tag table 33b to the cache controller 38 in order to judge the existence of cache miss during thread execution.

The way selector 39 chooses one of the least recently used way number (lruway) and the replaceable way number (Rep) according to the replacement way number effective flag (V) of cache tag table 33b, and outputs it to the way determinator 37b. The way selector 39 sets it to the cache-missed address storage 35 as the replaceable way number (RepWay). The way determinator 37b determines the way which should be replaced according to way determination algorithm at cache-missed and at replacement way number (Rep) setup, and sets up the replacement way number effective flag (V) and replacement way number (Rep) in the cache tag table 33b.

The cache controller 38 decides which way is accessed at thread execution and cache replacement. Moreover, the least recently used way number (lruWay) of the cache tag table 33a is set according to LRU.

The terminated ThID memory 403 of the thread comparator 36b memorizes terminated thread ID detached from created thread ID cue 20. The first-in first-out (FIFO) controller 400 in the thread comparator 36b makes the terminated ThID be moved and memorized one by one from the terminated ThID memory 403 of the first entry unit 361 to the terminated ThID memory 403 of the fourth entry unit 364. The thread predictor 405 predicts ThID of thread performed from now on, and the predicted ThID memory 404 memorizes the ThID.

Moreover, terminated thread comparators 401 and 402 in the thread comparator 36b compare the terminated ThID memorized in the terminated ThID memory 403 with ThID stored in each way of the cache tag table 33b. The predicted thread comparators 406 and 407 of thread comparator 36b compare the predicted ThID memorized by the predicted ThID memory 404 with the ThID stored in each way of the cache tag table 33b.

The way 0 hit OR gate 366 and the way 1 hit OR gate 365 in the thread comparator 36b examine the logical sum of outputs of the terminated Th comparators 401 and 402 in the first to fourth entry units 361, 362, 363, and 364. On the other hand, the way 0 hit NOR gate 368 and the way 1 hit NOR gate 367 examine the negative logical sum of outputs of the predicted thread comparators 406 and 407 in the first predicted entry unit 501 and the second predicted entry unit 502. The way 0 hit AND gate 504 and the way 1 hit AND gate 503 output to a way determinator 37b if there is any data used by the thread, which was finally terminated or which is predicted to perform in each way.

(The Cache Replacement Method)

(a) A thread ID generated in a thread generator 10 by a demand of processing is attached to a generated thread ID cue 20 one by one. The thread ID that comes to the turn of execution is detached from the generated thread ID cue 20. The thread ID is memorized in the instruction access address storage 31 as current thread ID (currThID) as well as stored in the terminated ThID memory 403 of the thread comparator 36b.

(b) A current page frame number (currPFN) and a current index (currindex) are stored in the instruction access address storage 31 as an address of the memory which thread with current thread ID accesses by the memory management unit (MMU) (not shown).

(c) The current index (currindex) is chosen by the index selector 32b, and the search of the cache tag table 33b is carried out by using the current index (currIndex).

(d) Next, the current page frame number (currPFN) stored in the instruction access address storage 31 is read and compared with PFN stored in the memory of the cache tag table 33b searched by the PFN comparator 34 by using the current index (currIndex). The result is notified to the cache controller 38 whether it is matched in each way. When there is a matched way, the PFN comparator 34 notifies coincidence of an address to the cache controller 38, and the cache controller 38 makes the data of the matched way to be used for processing, and sets the way number which was not matched as the least recently used way (lruWay). When there are no matched ways, cache replacement process is performed.

(Cache Replacement Process)

(e) When the instruction which accesses a cache memory is performing, if the replacement way number effective flag (V) stored in the memory of cache tag table 33b is searched by using the current index (currindex) is 1 (ON) and the page frame number (PFN) comparator 34 detects disagreement (cache missed), the way selector 39 will set a replacement way number (Rep) to the replaceable way number (RepWay) of the cache-missed address storage 35, and the process will be jumped to (1). (f) If the replacement way number effective flag (V) is 0 (OFF) and the page frame number (PFN) comparator 34 detects disagreement (cache missed), the least recently used way (lruWay) will be outputted to the way determinator 37b, and will be set to the replaceable way number (RepWay) of the cache-missed address storage 35. ThID stored in the memory of the cache tag table 33b, searched by the thread comparator 36b using the current index (currindex) is read from each way.

(g) The cycle acquisition controller 41 finds the cycle for which the cache memory is not used, and makes the value of a counter 40 output to index selector 32b as an index. ThID stored in the memory of the cache tag table 33b, searched by the thread comparator 36b using the index is read from each way.

(h) Next, the terminated ThID stored in each terminated ThID memory 403 is compared with ThID read from each way by each terminated thread comparators 401 and 402 in the first to fourth entry units 361, 362, 363, and 364 of thread comparator 36b. The logical sum of a comparison result is outputted to the way 0 hit AND gate 504 and the way 1 hit AND gate 503 by the way 0 hit OR gate 366 and the way 1 hit OR gate 365, respectively.

(i) On the other hand, the predicted ThID stored in each predicted ThID memory 404 is compared with ThID read from each way in the first predicted entry unit 501 and the second predicted entry unit 502 by each predicted thread comparators 406 and 407. The negative logical sum of a comparison result is outputted to the way 0 hit AND gate 504 and the way 1 hit AND gate 503 by the way 0 hit NOR gate 368 and the way 1 hit NOR gate 367, respectively.

(j) The logical product of the data inputted by the (h) and the (i) is outputted to the way determinator 37b by the way 0 hit AND gate 504 and the way 1 hit AND gate 503.

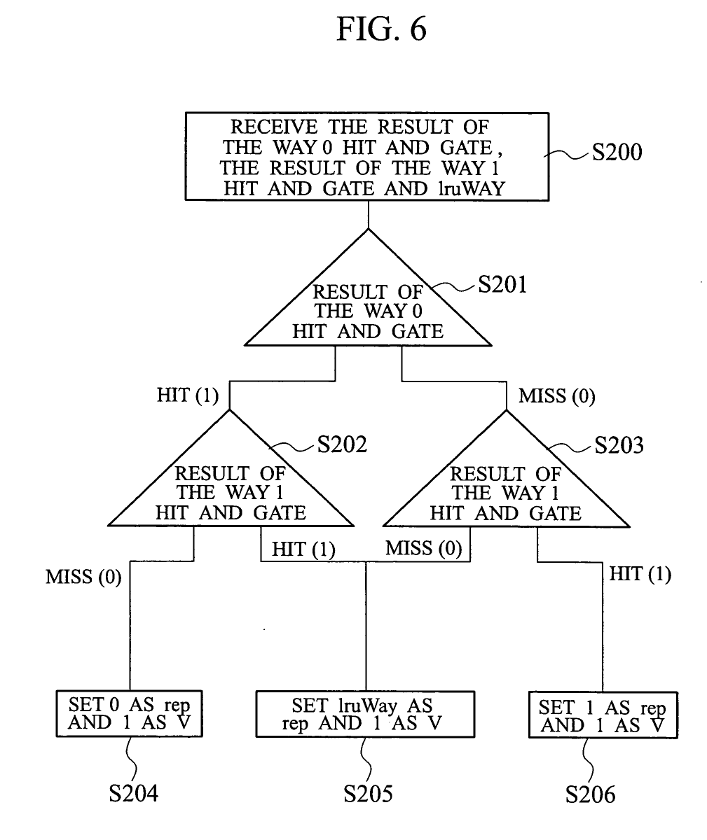

(k) Next, while the way which should be replaced is determined by the algorithm shown in FIG. 6 and will be set as a replacement way number (Rep) in the cache tag table 33b by the way determinator 37b, and the replacement way number effective flag (V) is set to 1. The algorithm is explained in full detail previously.

(l) When the instruction which accesses cache generates a cache missed, the current thread ID (currThID), the current page frame number (currPFN) and the current index (currindex) used as the index stored in the instruction access address storage 31 are set as the missed thread ID (missThID), the missed page frame number (missPFN), and missed index (missindex) in the cache-missed address storage 35, respectively.

(m) Data is read from the cache controller 38 external memory by making a missed page frame number (missPFN) and a missed index (missindex) into an address. The read data is written in the data part of a cache memory (not shown).

(n) Then, a missed index (missindex) is chosen by the index selector 32b, and the index of the cache tag table 33b is carried out by using the missed index (missIndex).

(o) The cache controller 38 reads the replaceable way number (RepWay) in the cache-missed address storage 35, and sets the missed thread ID (missThID) and a missed page frame number (missPFN) to the way which should be replaced according to the RepWay as a thread ID (ThID) and a page frame number (PFN) in use. The replacement way number effective flag (V) is set to 0. Thereby, the replacement of cache is completed. (Way determination algorithm)

S200: Receive the result of the way 0 hit AND gate 504 and the result of the way 1 hit AND gate 503. Read the least recently used way (lruWay) further stored in the memory of the cache tag table 33b.

S201: Judge the result of the way 0 hit AND gate 504. That is, it examines whether the ThID stored in the way 0 is matched with either of four terminated ThIDs and two predicted ThIDs. The result becomes a hit (1) only when the way 0 includes at least one of the Terminated ThIDs and none of the predicted ThIDs.

S202: In case the hit is made in S201, judge the result of the way 1 hit AND gate 503. It is a hit (1) only when the way 1 includes at least one of the terminated ThIDs and none of the predicted ThIDs.

S203: In case the miss is made by S201, judge the result of the way 1 hit AND gate 503. It is a hit (1) only when the way 1 includes at least one of the terminated ThIDs and none of the predicted ThIDs.

S204: In case the miss is made in S202, set 0 as a replacement way number (Rep), and set 1 as a replacement way number effective flag (V).

S205: In case the hit is made in S202, or the miss is made in S203, set the least recently used way (lruWay) as a replacement way number (Rep), and set 1 as a replacement way number effective flag (V).

S206: In case the hit is made in S203, set 1 as a replacement way number (Rep), and set 1 as a replacement way number effective flag (V).

The following logic is realized by this algorithm:
When only ThID of a way 0 is matched with the terminated ThID, set the way 0 as a replacement way number (Rep).
When only ThID of a way 1 is matched with the terminated ThID, set the way 1 as a replacement way number (Rep).
When ThID of both ways is matched with the terminated ThID or each is matched with the predicted ThID, set the value of lruWay already set in the memory of the cache tag table 33b as a replacement way number (Rep).

According to the cache replacement equipment 30b and the cache replacement method according to the second embodiment, the cache used by the terminated thread can be replaced. Replacement of the cache used by the thread that will be performed soon can be avoided. Therefore, the use efficiency of cache increases and a decline in the rate of a miss-hit can be expected.

### OTHER EMBODIMENTS

Various modifications will become possible for those skilled in the art after receiving the teachings of the present disclosure without departing from the scope thereof.

It cannot be overemphasized that another embodiment is possible and the same effect is acquired by replacing thread comparator 36a of the cache replacement equipment 30a in the first embodiment and thread comparator 36b of the cache replacement equipment 30b in the second embodiment.

Although comparison with the terminated thread ID was performed in the thread comparator 36a and 36b, it can compare instead with a thread ID (executing thread ID) of creating thread ID cue, and unmatched cache can be made applicable to replacement.

Moreover, even if it is threads under execution, it is also possible to make threads with a low priority applicable to replacement. Furthermore, it is applicable also to set not only associative cache but full associative cache.

Thus, this invention of including the form of various operations that have not been indicated here is natural. The technical range of this invention is defined only according to the invention specification matter that starts an appropriate claim from the above-mentioned explanation.

1. A cache replacement equipment, the equipment comprising:
a cache tag table having a plurality of ways;
a thread comparator connected to the cache tag table configured to compare a first thread number stored in the cache tag table with a second thread number to be performed; and
a way determinator connected with the cache tag table and the thread comparator configured to determine one of the ways to be replaced.

2. The cache replacement equipment according to claim 1, further comprising:
an index selector connected to the cache tag table;
an instruction access address storage element connected to the index selector; and
a cache-missed address storage element connected with the index selector and the instruction access address storage element.

3. The cache replacement equipment according to claim 2, further comprising a page frame number comparator connected to the cache tag table and the instruction access address storage element.

4. The cache replacement equipment according to claim 3, further comprising a cache controller connected to the cache tag table, the cache-missed address storage element and the page frame number comparator.

5. The cache replacement equipment according to claim 4, wherein the page frame number comparator provides an inharmonious way number to the cache controller after comparing the page frame number in the cache tag table with an executing page frame number in the instruction access address storage.

6. The cache replacement equipment according to claim 4, wherein the thread comparator comprises an entry unit comprising:
a terminated thread ID memory configured to store a terminated thread ID; and
a terminated thread comparator configured to compare the terminated thread ID with the thread ID inputted from each way of the cache tag table; and
a way n hit OR gate connected to the terminated thread comparator (n is a natural number).

7. The cache replacement equipment according to claim 6, wherein the way determinator provides an replaceable way number to the cache-missed address storage after examining an output of the way n hit OR gate of the thread comparator and the least recently used way number outputted from the cache tag table.

8. The cache replacement equipment according to claim 6, wherein the thread comparator comprises:
a thread predictor;
a predicted entry unit comprising:
a predicted thread ID memory configured to store a predicted thread ID outputted from the thread predictor; and
a predicted thread comparator configured to compare the predicted thread ID with the thread ID inputted from each way of the cache tag table;
a way n hit NOR gate connected to the predicted thread comparator; and
a way n hit AND gate connected to the way n hit OR gate and the way n hit NOR gate.

9. The cache replacement equipment according to claim 8, wherein the way determinator provides an replaceable way number to the cache-missed address storage after examining an output of the way n hit AND gate of the thread comparator and the least recently used way number outputted from the cache tag table.

10. The cache replacement equipment according to claim 2, further comprising:
a counter connected to the index selector;
a cycle acquisition controller connected to the index selector; and
a way selector connected to the cache tag table, the cache-missed address storage, and the way determinator.

11. The cache replacement equipment according to claim 10, wherein the cache tag table stores a thread ID, a page frame number, an effective flag, a replacement way number and the least recently used way number.

12. The cache replacement equipment according to claim 11, wherein the way selector provides one of the replacement way number and the least recently used way number based on the effective flag in the cache tag table to the way determinator.

13. The cache replacement equipment according to claim 10, wherein the instruction access address storage element stores an executing thread ID, a page frame number and an index.

14. The cache replacement equipment according to claim 10, wherein the cache-missed address storage element stores a cache-missed thread ID, a page frame number, an index and a replaceable way number.

15. The cache replacement equipment according to claim 10, wherein the page frame number comparator provides an inharmonious way number to the cache controller after comparing the page frame number in the cache tag table with an executing page frame number in the instruction access address storage.

16. The cache replacement equipment according to claim 10, wherein the thread comparator comprises:
an entry unit comprising:
a terminated thread ID memory configured to store a terminated thread ID; and
a terminated thread comparator configured to compare the terminated thread ID with the thread ID inputted from each way of the cache tag table; and
a way n hit OR gate connected to the terminated thread comparator (n is a natural number).

17. The cache replacement equipment according to claim 16, wherein the way determinator provides an replaceable way number to the cache-missed address storage after examining an output of the way n hit OR gate of the thread comparator and the least recently used way number outputted from the cache tag table.

18. The cache replacement equipment according to claim 16, wherein the thread comparator comprises:
a thread predictor;
a predicted entry unit comprising:
a predicted thread ID memory configured to store a predicted thread ID outputted from the thread predictor; and
a predicted thread comparator configured to compare the predicted thread ID with the thread ID inputted from each way of the cache tag table;
a way n hit NOR gate connected to the predicted thread comparator; and
a way n hit AND gate connected to the way n hit OR gate and the way n hit NOR gate.

19. A cache replacement method, comprising:
delivering a thread ID in each way of a cache tag table to a thread comparator;
transferring a result to a way determinator after comparing a stored terminated thread ID with the thread ID in the thread comparator; and
determining a replaceable way based on the result and the least recently used way number in the cache tag table.

20. A cache replacement method, comprising:
delivering a thread ID in each way of a cache tag table indexed with a value of a counter to a way selector in an idle cycle of cache access by instructions;
delivering an effective flag, a replacement way number and the least recently used way number to a way selector in the idle cycle;
transferring a result of comparison of a terminated thread ID in the thread comparator with the thread ID from the thread comparator to the way determinator;
supplying one of the replacement way number and the least recently used way number from the way selector to the way determinator based on the value of the effective flag; and
determining a replaceable way number and overwriting the replaceable way number onto the replacement way number of each way of the cache tag table indexed with the value of the counter, and setting the effective flag as ON by the way determinator.
